(19) United States
(12) Patent Application Publication
(10) Pub. No.: US 2007/0297536 A1
(43) Pub. Date: Dec. 27, 2007

(54) DC OFFSET REMOVAL APPARATUS AND DC OFFSET REMOVAL METHOD

(75) Inventors: Tomohiro Yui, Kanagawa (JP); Yukiteru Murao, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/766,373

(22) Filed: Jun. 21, 2007

(30) Foreign Application Priority Data
Jun. 23, 2006 (JP) 2006-174604

(51) Int. Cl. H04L 25/06

(52) U.S. Cl. 375/319

(57) ABSTRACT

A DC offset removal apparatus and a DC offset removal method that can highly accurately detect and remove a DC offset within a burst and that have a relatively small processing load. DC offset compensating processing section 101 includes maximum value searching section 104 that calculates maximum value estimation value MAX of received signals; minimum value searching section 105 that calculates minimum value estimation value MIN of the received signals; average value calculating section 106 that calculates average value AVE of the received signals; DC offset detecting section 107 that calculates a DC offset value based on the calculated maximum value estimation value MAX, minimum value estimation value MIN and average value AVE; and DC offset removal section 108 that removes the calculated DC offset value from the received signal. When |AVE−(MAX+MIN)/2|≧K, AVE+{(MAX+MIN)/2−AVE}×W is used as the DC offset value, and, when |AVE−(MAX+MIN)/2|<K, AVE is used as the DC offset value.

### CROSS REFERENCE TO RELATED APPLICATIONS

The disclosure of Japanese Patent Application No. 2006-174604 filed on Jun. 23, 2006 including the specification, drawings and abstract is incorporated herein by reference in its entirety.

### BACKGROUND OF THE INVENTION

1. Field of the Invention

The present invention relates to a DC offset removal apparatus provided to a receiver in wireless communication and a DC offset removal method, more particular, a DC offset removal apparatus and a DC offset removal method mainly used for a receiver in digital mobile communication.

2. Description of Related Art

A receiver in digital mobile communication simultaneously receives radio waves of a plurality of paths with different propagation times, due to the influence of multipath fading which can occur in a radio link. Because of this, delay distortion occurs in a received signal, and bit error rate characteristics deteriorate. The delay distortion increases with a higher symbol rate, and therefore the influence of the delay distortion cannot be ignored in future high-speed digital mobile communication devices, and the removal of the delay distortion has become essential.

An equalizer is a representative means for correcting the delay distortion. In wireless communication, an equalizer is conventionally provided to a receiver that performs high-speed transmission. Furthermore, in recent years, an equalizer has started to be provided, for example, to a mobile telephone that uses GSM (Global System for Mobile Communications) which is a digital mobile telephone standard in Europe. In addition, there are more receivers where equalization accuracy and bit error rate characteristics are improved by estimating a DC offset component which may occur mainly in a radio RF section from an average value of received signals and removing the DC offset component, as pre-processing by the equalizer.

FIG. 1 is a block diagram showing the configuration of a receiver having a conventional DC offset removal apparatus. FIG. 2 shows the configuration of a DC offset compensating processing section of the conventional DC offset removal apparatus. In FIGS. 1 and 2, receiver 10 having the DC offset removal apparatus includes DC offset compensating processing section 11, equalizing processing section 12, and decoding processing section 13. DC offset compensating processing section 11 includes average value calculating section 14 and DC offset removal section 15.

In DC offset compensating processing section 11, a DC offset component is estimated from an average value of received signals by average value calculating section 14 and then removed by DC offset removal section 15.

In the above-described configuration, received signals which are converted into digital baseband signals are inputted to DC offset compensating processing section 11, and DC offset compensating processing is performed. Equalizing processing section 12 equalizes the DC offset compensated received signals subjected to DC offset compensating processing. Decoding processing section 13 decodes the received signals equalized by equalizing processing section 12. Specifically, DC offset compensating processing section 11 performs DC offset compensating processing so that average value calculating section 14 calculates an average value of the received signals, and DC offset removal section 15 removes the average value calculated by average value calculating section 14 from the received signals as a DC offset value.

In recent years, in order to reduce the circuit scale (cost) of a radio RF section, a direct conversion reception scheme has started to be adopted instead of a heterodyne reception scheme in which a received frequency is converted into an intermediate frequency. However, along with the adoption of the direct conversion reception scheme, in a narrow-band digital modulation scheme used in GSM and the like, a DC offset component remains in a detected output (baseband received signal) of the receiver due to a received signal frequency being equal to a local oscillator frequency. In addition, particularly in an EDGE scheme which is a third-generation version of GSM and is capable of performing high-speed bit rate communication, the distance between symbols is shorter than that in GSM, and therefore it is sensitive to residual DC offsets, and it is difficult to remove a DC offset component by estimation of an average value of received signals, and the bit error rate characteristics may deteriorate.

In a conventional DC offset removal algorithm, in order to remove a DC offset, a digital baseband signal is mapped onto an IQ diagram and by two-dimensional fitting of geometric graphics using subsets of signal values, I and Q coordinates of a center point are determined. By a change in the center point, it is possible to capture a change in a dynamic DC offset (see Japanese Patent Application Laid-Open No. 2000-278335, for example).

However, in such a conventional DC offset removal apparatus, if calculation is implemented to determine a center point with respect to arbitrary consecutive subsets of a digital baseband signal, processing load increases. Unless this processing load is ensured, a DC offset cannot be highly accurately detected and removed within a burst.

Namely, although, in recent years, a direct conversion scheme has started to be adopted in order to reduce the circuit scale of a radio RF section, the amount of residual DC offset components increases compared to a conventional heterodyne scheme. In addition, a residual DC offset component is one of the factors contributing to the deterioration in reception characteristics while there is an increasing demand for reception characteristics. Thus, there is a problem that it is difficult to highly accurately remove a residual DC offset component by the conventional average value estimation.

### SUMMARY OF THE INVENTION

It is therefore an object of the present invention to provide a DC offset removal apparatus and a DC offset removal method that can highly accurately detect and remove a DC offset within a burst and that require a relatively small processing load.

According to an aspect of the invention, a DC offset removal apparatus includes: a maximum/minimum value searching section that calculates a maximum value estimation value and a minimum value estimation value of received signals which are converted into digital baseband signals; a DC offset detecting section that uses half of a sum of the maximum value estimation value and the minimum value estimation value based on the maximum value estimation value and the minimum value estimation value calculated by the maximum/minimum value searching section, as a DC offset value; and a DC offset removal section that removes the DC offset value calculated by the DC offset detecting section, from the received signals.

According to an aspect of the invention, a DC offset removal apparatus includes: a maximum/minimum value searching section that calculates a maximum value estimation value and a minimum value estimation value of received signals which are converted into digital baseband signals; an average value calculating section that calculates an average value of the received signals; a DC offset detecting section that calculates a DC offset value based on the maximum value estimation value and the minimum value estimation value calculated by the maximum/minimum value searching section and the average value calculated by the average value calculating section; and a DC offset removal section that removes the DC offset value calculated by the DC offset detecting section, from the received signals, wherein: when an absolute value of a difference between the average value and half of a sum of the maximum value estimation value and the minimum value estimation value is equal to or greater than a first constant (the first constant is an integer equal to or greater than 0), the DC offset detecting section uses, as the DC offset value, a sum of the average value and a value obtained by multiplying a second constant (the second constant is a real number equal to or greater than 0 and less than 1) by a result of subtracting the average value from the half of a sum of the maximum value estimation value and the minimum value estimation value; and when the absolute value of the difference between the average value and the half of a sum of the maximum value estimation value and the minimum value estimation value is smaller than the first constant, the DC offset detecting section uses the average value as the DC offset value.

According to an aspect of the invention, a DC offset removal method includes: a step of calculating a maximum value estimation value and a minimum value estimation value of received signals which are converted into digital baseband signals; a DC offset detecting step of using half of the maximum value estimation value and the minimum value estimation value, as a DC offset value; and a step of removing the calculated DC offset value from the received signals.

According to another aspect of the invention, a DC offset removal method includes: a step of calculating a maximum value estimation value and a minimum value estimation value of received signals which are converted into digital baseband signals; a step of calculating an average value of the received signals; a DC offset detecting step of calculating a DC offset value based on the calculated maximum value estimation value and minimum value estimation value and the average value; and a step of removing the calculated DC offset value from the received signals.

### BRIEF DESCRIPTION OF THE DRAWINGS

FIG. 1 is a block diagram showing the configuration of a receiver having a conventional DC offset removal apparatus;

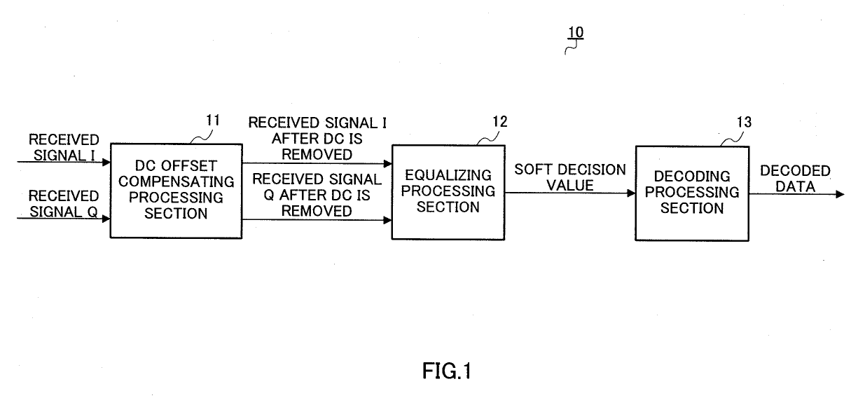

FIG. 2 shows the configuration of a DC offset compensating processing section of the conventional DC offset removal apparatus;

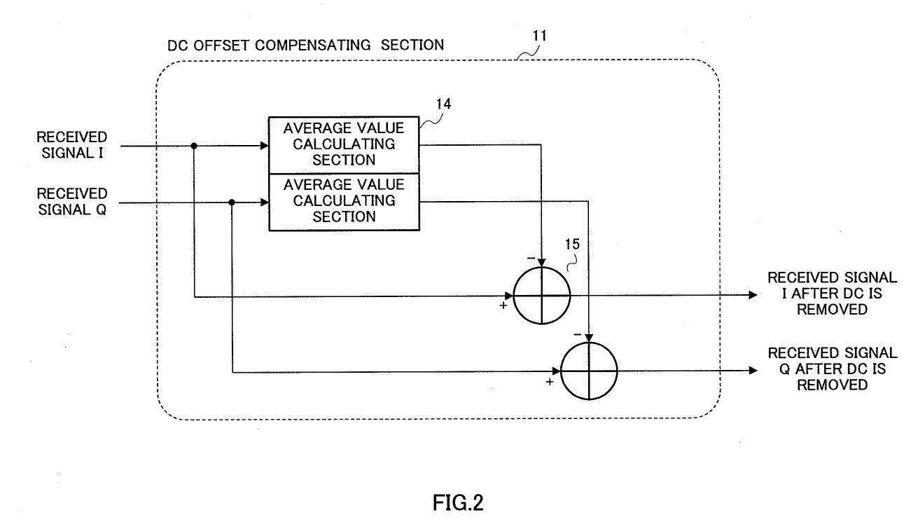

FIG. 3 is a block diagram showing the configuration of a receiver having a DC offset removal apparatus according to Embodiment 1 of the present invention;

FIG. 4 shows the configuration of a DC offset compensating processing section of the DC offset removal apparatus according to Embodiment 1;

FIG. 5 shows the configuration of a DC offset detecting section of the DC offset removal apparatus according to Embodiment 1;

FIG. 6 shows the configuration of a maximum value searching section of the DC offset removal apparatus according to Embodiment 1;

FIG. 7 shows the configuration of a minimum value searching section of the DC offset removal apparatus according to Embodiment 1;

FIGS. 8A and 8B describe search of a maximum value of received signal I in the number of symbols for 8PSK modulation in the DC offset removal apparatus according to Embodiment 1;

FIG. 9 shows the configuration of a maximum/minimum value searching section of a DC offset removal apparatus according to Embodiment 2 of the present invention;

FIG. 10 shows the configuration of a maximum/minimum value searching section of a DC offset removal apparatus according to Embodiment 3 of the present invention; and

FIG. 11 shows the configuration of a DC offset detecting section of a DC offset removal apparatus according to Embodiment 4 of the present invention.

### DETAILED DESCRIPTION OF THE PREFERRED EMBODIMENT

Embodiments of the present invention will be described in detail below with reference to the drawings.

### Embodiment 1

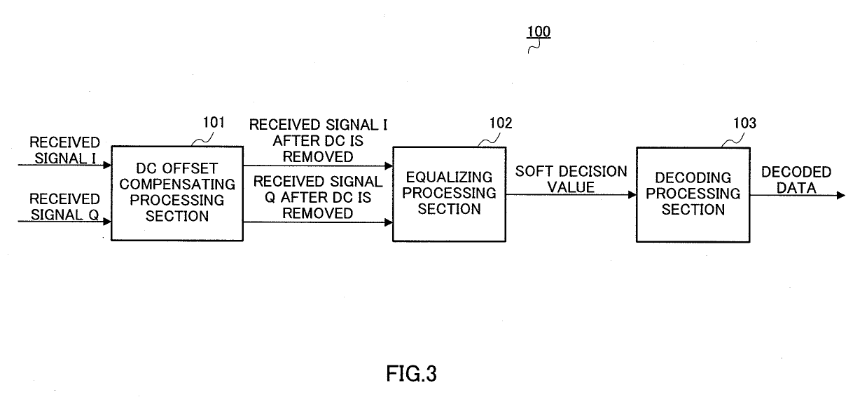

FIG. 3 is a block diagram showing the configuration of a receiver having a DC offset removal apparatus according to Embodiment 1 of the present invention. This embodiment shows an example of applying the present invention to a receiver for digital mobile communication that uses the GSM scheme.

In FIG. 3, receiver 100 having a DC offset removal apparatus includes DC offset compensating processing section 101 that receives as input received signals I and Q which are converted into digital baseband signals and removes DC offsets from received signals I and Q; equalizing processing section 102 that equalizes the DC offset compensated received signals subjected to DC offset compensating processing; and decoding processing section 103 that decodes the received signals equalized by equalizing processing section 102.

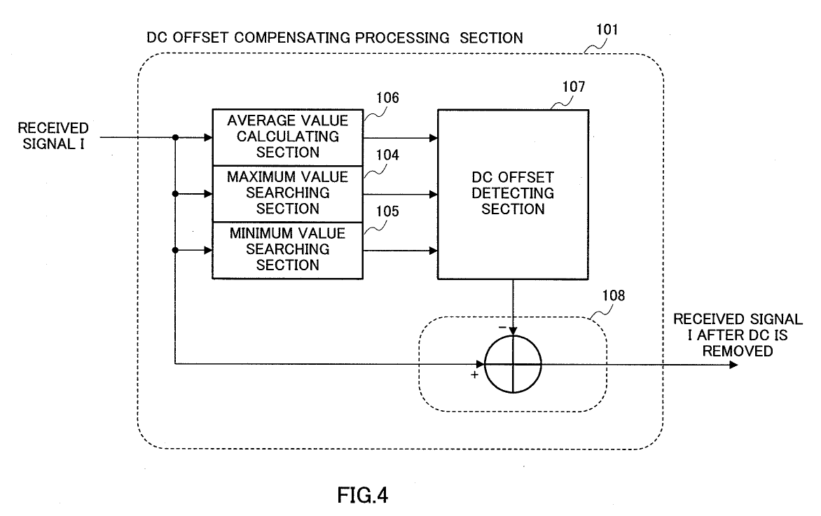

FIG. 4 shows the configuration of DC offset compensating processing section 101. The same processing is performed independently for I-phase (in-phase) and Q-phase (quadrature-phase) components, and therefore the processing for the I-phase component will be representatively described.

In FIG. 4, DC offset compensating processing section 101 includes maximum value searching section 104, minimum value searching section 105, average value calculating section 106, DC offset detecting section 107 and DC offset removal section 108. In addition, the same configuration as that in FIG. 4 is also adopted for received signal Q.

Maximum value searching section 104 calculates a maximum value estimation value of received signals (received signal I here, but the same also applies to received signal Q). Minimum value searching section 105 calculates a minimum value estimation value of the received signals. Average value calculating section 106 calculates an average value of the received signals.

DC offset detecting section 107 calculates a DC offset value based on the maximum and minimum values calculated by maximum value searching section 104 and the minimum value searching section 105, respectively, and the average value calculated by average value calculating section 106.

DC offset removal section 108 is a subtractor that removes the DC offset value calculated by DC offset detecting section 107 from the received signals.

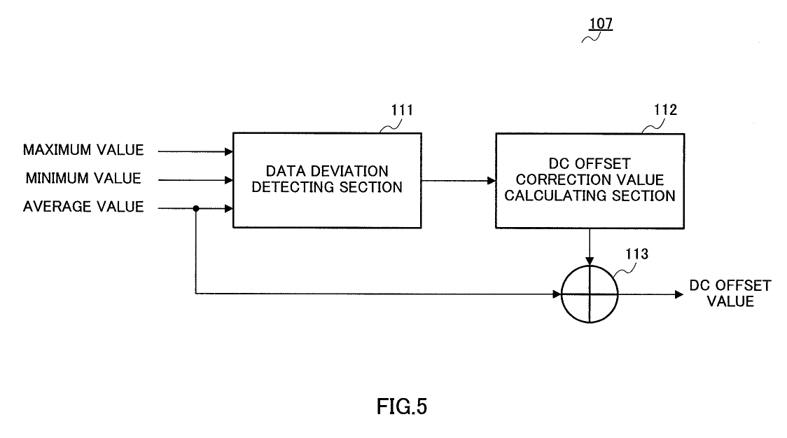

FIG. 5 shows the configuration of DC offset detecting section 107.

In FIG. 5, DC offset detecting section 107 includes data deviation detecting section 111 that calculates a difference between an average value of a maximum value and a minimum value and an average value outputted from average value calculating section 106; DC offset correction value calculating section 112 that compares a value that takes the absolute value of the difference between the average values with a first constant and then outputs 0 as a DC offset correction value, if the first constant is greater than the absolute value, and otherwise outputs, as a DC offset correction value, a value obtained by multiplying the difference between the average values by a second constant; and DC offset correcting section 113 that calculates a DC offset in which data deviation is eliminated by adding the DC offset correction value and the average value outputted from average value calculating section 106. DC offset detection operation will be described in detail later.

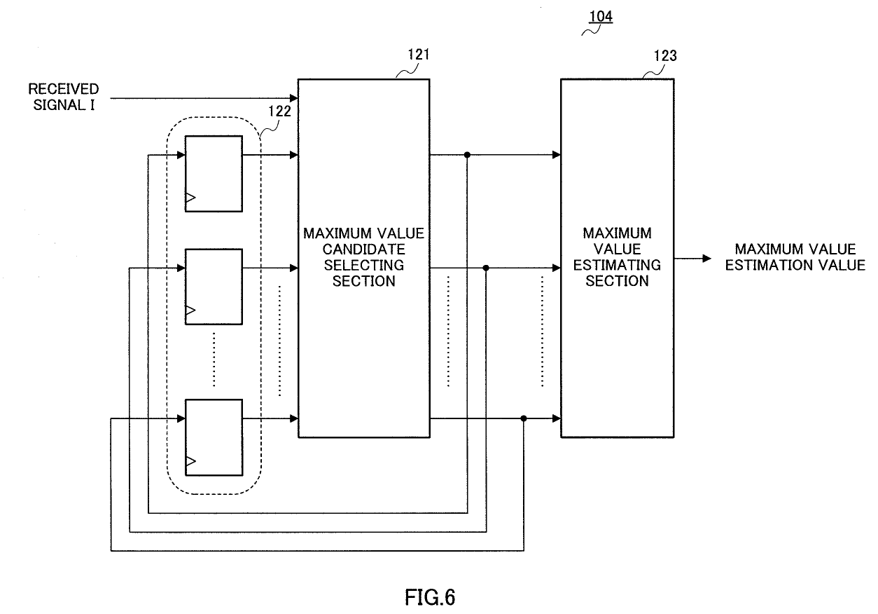

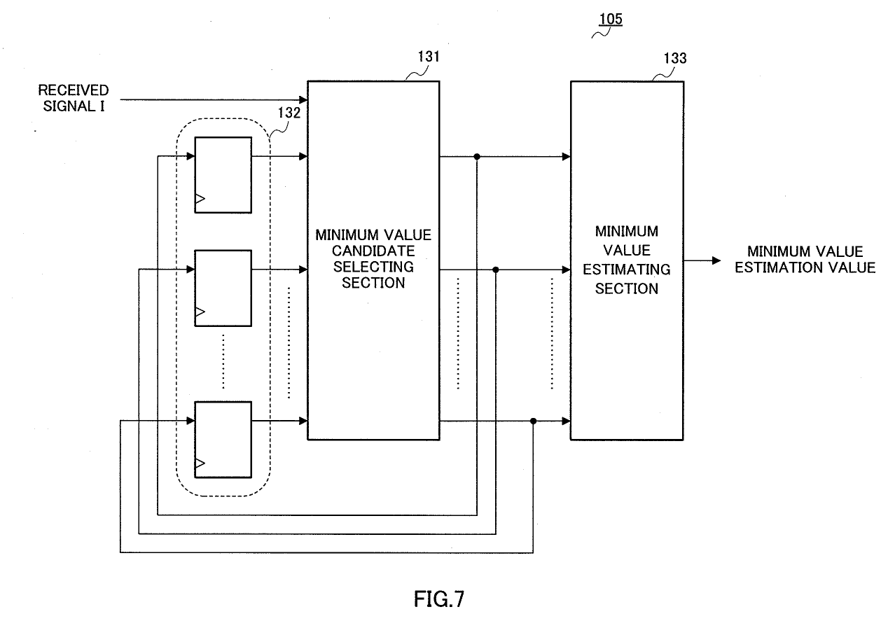

FIG. 6 shows the configuration of maximum value searching section 104, and FIG. 7 shows the configuration of minimum value searching section 105. Maximum value searching section 104 and minimum value searching section 105 perform search using the same method and therefore employ the same configuration.

In FIG. 6, maximum value searching section 104 includes maximum value candidate selecting section 121 that receives as input a received signal and S maximum value candidates received up to the point of the reception of the received signal, compares the S maximum value candidates with the received signal, and outputs, if the received signal is greater than a given maximum value candidate, the S maximum value candidates where a minimum value among the S maximum value candidates is replaced with the received signal, and outputs, if the received signal is smaller than any of the maximum value candidates, the S maximum value candidates as is; maximum value candidate storage section 122 that updates candidate values for each sample of the received signal and stores the candidate values; and maximum value estimating section 123 that receives as input the S maximum value candidates which are outputted from maximum value candidate selecting section 121 after all received signal samples are read into maximum value candidate selecting section 121, calculates an average value of the S maximum value candidates, and then outputs the average value as a maximum value estimation value.

In FIG. 7, minimum value searching section 105 includes minimum value candidate selecting section 131 that receives as input a received signal and S minimum value candidates received up to the point of the reception of the received signal, compares the S minimum value candidates with the received signal, and outputs, if the received signal is smaller than a given minimum value candidate, the S minimum value candidates where a maximum value among the S minimum value candidates is replaced with the received signal, and outputs, if the received signal is greater than any of the minimum value candidates, the S minimum value candidates as is; minimum value candidate storage section 132 that updates candidate values for each sample of the received signal and stores the candidate values; and minimum value estimating section 133 that receives as input the S minimum value candidates which are outputted from minimum value candidate selecting section 131 after all received signal samples are read into minimum value candidate selecting section 131, calculates an average value of the S minimum value candidates, and then outputs the average value as a minimum value estimation value.

DC offset removal operation by receiver 100 having the DC offset removal apparatus configured as described above will be described below.

Receiver 100 having the DC offset removal apparatus receives as input received signals which are converted into digital baseband signals. It is assumed that a sampling period of the received signals is Ts, a burst period is Tb, and the number of samples that can be present in the burst period is N (=Tb/Ts). The received signals are quadrature modulated to I-phase and Q-phase components. The same processing is performed independently for the I-phase and Q-phase components, and therefore only the processing for the I-phase component will be described.

In FIG. 4, maximum value searching section 104 and minimum value searching section 105 calculate a maximum value estimation value and a minimum value estimation value of a received signal, respectively. Average value calculating section 106 calculates an average value of the received signals.

DC offset detecting section 107 calculates a DC offset value based on maximum value estimation value MAX and minimum value estimation value MIN which are calculated by maximum value searching section 104 and minimum value searching section 105, respectively, and average value AVE calculated by average value calculating section 106, first constant K (K is an integer equal to or greater than 0) which is determined in advance, and second constant W (W is a real number of 0<W≦1), and according to the following equation 1:

if AVE−(MAX+MIN)/2≧K, DC offset value=AVE+{(MAX+MIN)/2−AVE}×W (1),

otherwise,

DC offset value=AVE.

First constant K is a constant determined based on the reliability of MAX and MIN (an estimation error between a true maximum/minimum value and MAX/MIN). Second constant W is a constant determined based on the reliability of AVE and the reliability of MAX and MIN and is a weighting constant indicating that, when second constant W is 1, the reliability of MAX and MIN is highest compared to the reliability of AVE.

Maximum value estimation value MAX (minimum value estimation value MIN) can be determined by scanning maximum values (minimum values) up to a CEILING (N/S)-th maximum (minimum) value as the number of modulation symbol points on an IQ plane S, and calculating an average value of the N/S maximum values (an average value of the N/S minimum values).

A symbol point which takes the maximum/minimum value of the I-phase/Q-phase component can be determined by a modulation scheme, and therefore maximum value estimation value MAX (minimum value estimation value MIN) is obtained by taking an average value of each of CEILING (N/S) sets of maximum and minimum values. CEILING (N/S) is equal to or greater than the number of samples including the symbol point which takes the maximum/minimum value and is as less as possible than the number of samples which can take the symbol point. It is thereby possible to reduce errors in maximum/minimum value estimation even in circumstances where there is a lot of noise.

Meanwhile, a conventional method in which an average value is considered as a DC offset value uses an assumption that if samples are present in a segment where an average value of a received signal is sufficiently long, and when there is no DC offset component, the average value is 0. However, in processing that requires real-time property, it is not possible to take samples with a sufficiently long segment, and therefore there may be a case (hereinafter, referred to as a “special case”) where, even when there is no DC offset component, the average value does not become 0. In this embodiment, in order to cope with this special case, as indicated in the above-described equation 1, a maximum value and a minimum value are scanned from samples in a segment where the maximum value and the minimum value appear, and, when there is no DC offset component, detection and correction for the special case is performed assuming that an average value−(maximum value+minimum value)/2=0.

By this DC offset correction value calculation method, even in a special case where, even when there is no DC offset component, the average value does not become 0 due to data deviation of a received signal, a circuit that can detect the special case and highly accurately estimate a DC offset component can be implemented in a relatively small scale.

As shown in FIGS. 6 and 7, maximum value candidate selecting section 121 (or minimum value candidate selecting section 131) of maximum value searching section 104 (or minimum value searching section 105) receives as input a received signal and S maximum value candidates (or S minimum value candidates) received up to the point of the reception of the received signal, compares the S maximum value candidates (or the S minimum value candidates) with the received signal, and outputs, if the received signal is greater (or smaller) than a given maximum value candidate (or a given minimum value candidate), the S maximum value candidates (or the S minimum value candidates) where a minimum value among the S maximum value candidates (or a maximum value among the S minimum value candidates) is replaced with the received signal, and outputs, if the received signal is smaller (or greater) than any of the maximum value candidates (or the minimum value candidates), the S maximum value candidates (or the S minimum value candidates) as is. Maximum value candidate storage section 122 (or minimum value candidate storage section 132) updates candidate values for each sample of the received signal and stores the candidate values.

Maximum value estimating section 123 (or minimum value estimating section 133) receives as input the S maximum value candidates (or the S minimum value candidates) which are outputted from maximum value candidate selecting section 121 (or minimum value candidate selecting section 131) after all received signal samples are read into maximum value candidate selecting section 121 (or minimum value candidate selecting section 131), calculates an average value of the S maximum value candidates (or the S minimum value candidates), and then outputs the average value as a maximum value estimation value (or a minimum value estimation value). By this configuration, it is possible to approximate a maximum/minimum value estimation value to a maximum/minimum value without noise or fading (hereinafter, referred to as a “true maximum/minimum value”).

In this embodiment, by adopting a search method as will be described later, upon searching a maximum/minimum value, a more highly accurate maximum/minimum value is obtained without increasing the circuit scale.

Specifically, in maximum value searching section 104 and minimum value searching section 105, when a minimum integer equal to or greater than a value obtained by dividing the number of samples used in DC offset processing by the number of modulation symbol points which depends on a modulation scheme is S (S is an integer equal to or greater than 1), a value obtained by averaging first to S-th maximum/minimum values is used as a maximum/minimum value estimation value. In this case, by using the characteristics of the modulation scheme, the number of averaging is determined so that the number of samples in a symbol position that can take a maximum/minimum value becomes relatively large and the number of samples in a symbol position that cannot take the maximum/minimum value becomes relatively small. By this means, it is possible to approximate a maximum/minimum value estimation value to a true maximum/minimum value.

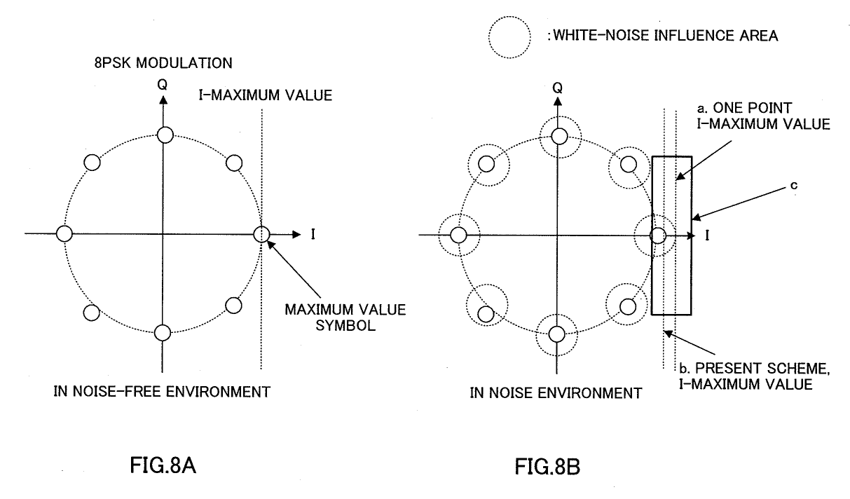

FIGS. 8A and 8B describe search of a maximum value of received signal I in the number of symbols for 8PSK modulation. FIG. 8A shows symbols in a noise-free environment where there is no noise, and FIG. 8B shows symbols in a noise environment where there is noise. Although FIGS. 8A and 8B describe a maximum value on an I-axis as an example, the same also applies to a minimum value on the I-axis. In addition, the same applies to received signal Q.

The number of symbols for 8PSK modulation is 8 and a symbol on the I-axis is a maximum value symbol. In the noise-free environment, a dotted line in FIG. 8A indicates an (I-maximum value). On the other hand, in the noise environment, as shown by dotted-line circles in FIG. 8B, symbols are within a white-noise influence area, and thus a true maximum value cannot always be obtained. For example, if search is inappropriate because of few samples, or the like, dotted line a. in FIG. 8B may be considered to be an (I−maximum value). According to this embodiment, doted line b. in FIG. 8B can be selected as the (I-maximum value). This is substantially equivalent to the maximum value symbol in the noise-free environment where there is no noise. In this embodiment, as shown by box c. in FIG. 8B, the probability of appearance of the maximum value symbol is ⅛, and, when the number of symbols for all processing is 156, averaging is performed for 20 maximum value symbols.

When the above-described search method is applied to the symbols in FIGS. 8A and 8B, by using the characteristics of an 8PSK modulation scheme, the number of averaging is determined so that the number of samples in a symbol position (for example, a symbol position of c. in FIG. 8B) that can take a maximum/minimum value becomes relatively large, and the number of samples in a symbol position that cannot take the maximum/minimum value becomes relatively small.

As described in detail above, according to this embodiment, DC offset compensating processing section 101 includes maximum value searching section 104 that calculates maximum value estimation value MAX of a received signal; minimum value searching section 105 that calculates minimum value estimation value MIN of the received signal; average value calculating section 106 that calculates average value AVE of the received signal; DC offset detecting section 107 that calculates a DC offset value based on the calculated maximum value estimation value MAX, minimum value estimation value MIN and average value AVE; and DC offset removal section 108 that removes the calculated DC offset value from the received signal. DC offset detecting section 107 uses AVE+{(MAX+MIN)/2−AVE}×W as a DC offset value when |AVE−(MAX+MIN)/2|≧K, and uses AVE as a DC offset value when |AVE−(MAX+MIN)/2|<K and thus can detect a DC offset value by such a simple calculation as calculating a difference between maximum value estimation value MAX and minimum value estimation value MIN, and average value AVE. Accordingly, it is possible to highly accurately compensate a DC offset with a relatively small circuit scale or with small processing load and can suppress the deterioration in reception characteristics. In the direct conversion scheme, although it is difficult to highly accurately remove a residual DC offset component by conventional average value estimation, according to this embodiment, a DC offset value can be highly accurately estimated even in circumstances where there is a lot of noise, such as the one shown in FIG. 8B, or even for a received signal having data deviation, as in a special case.

In this embodiment, average value calculating section 106 that calculates an average value of a received signal is provided and DC offset detecting section 107 detects a DC offset value based on maximum value estimation value MAX, minimum value estimation value MIN and average value AVE. Thus, even when valid maximum value estimation value MAX and minimum value estimation value MIN cannot be obtained for some reasons, the same average value AVE as that in the conventional example is ensured, and therefore there is an advantageous effect that DC offset compensation by DC offset detection is always performed.

It is also possible to detect a DC offset value only from maximum value estimation value MAX and minimum value estimation value MIN, so that it is possible to further reduce the circuit scale and processing load. In this case, processing is adaptively switched and performed between processing of detecting a DC offset value only from maximum value estimation value MAX and minimum value estimation value MIN when reception quality is good, and processing of detecting a DC offset value from maximum value estimation value MAX, minimum value estimation value MIN and average value AVE when reception quality is poor. Alternatively, it is preferable to ensure an appropriate DC offset value by adopting a method, such as holding a previous DC offset value and using the held DC offset value when valid maximum value estimation value MAX and minimum value estimation value MIN cannot be obtained.

### Embodiment 2

Embodiment 2 shows an example of determining the number of samples for MAX (MIN) in a maximum/minimum value searching section.

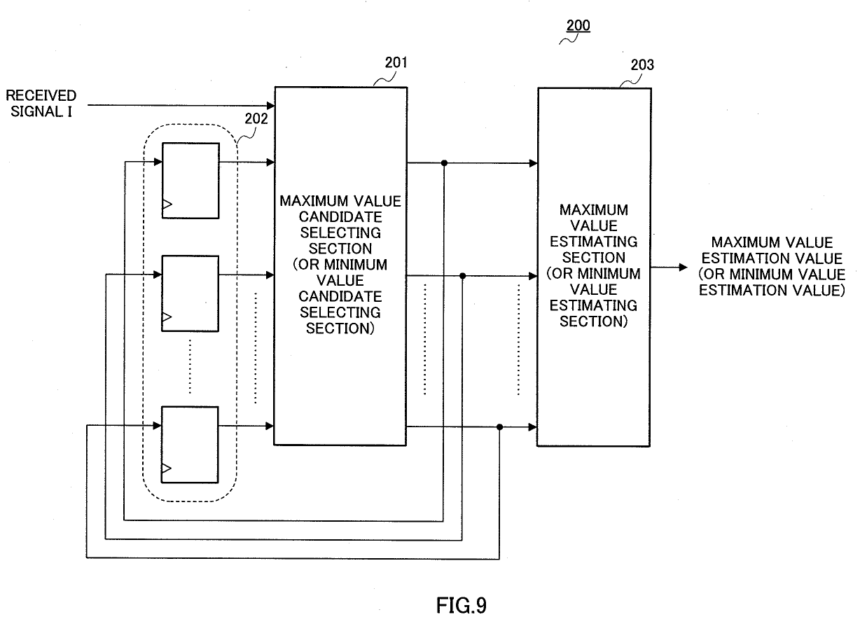

FIG. 9 shows the configuration of a maximum/minimum value searching section of a DC offset removal apparatus according to Embodiment 2 of the present invention. The entire configuration of the DC offset removal apparatus according to this embodiment and the configuration of a DC offset detecting section are the same as those in FIGS. 3 and 4, and therefore the description thereof will not be repeated.

The maximum/minimum value searching section of the DC offset removal apparatus according to this embodiment performs search using the same method for both a maximum value searching section and a minimum value searching section, and therefore they adopt the same configuration.

In FIG. 9, maximum/minimum value searching section 200 includes maximum/minimum value candidate selecting section 201 that receives as input a received signal and S maximum value candidates (or S minimum value candidates) received up to the point of the reception of the received signal, compares the S maximum value candidates (or the S minimum value candidates) with the received signal, and outputs, if the received signal is greater (or smaller) than a given maximum value candidate (or a given minimum value candidate), the S maximum value candidates (or the S minimum value candidates) where a minimum value among the S maximum value candidates (or a maximum value among the S minimum value candidates) is replaced with the received signal, and outputs, if the received signal is smaller (or greater) than any of the maximum value candidates (or any of the minimum value candidates), the S maximum value candidates (or the S minimum value candidates) as is; maximum/minimum value candidate storage section 202 that updates candidate values for each sample of the received signal and stores the candidate values; and maximum/minimum value estimating section 203 that receives as input the S maximum value candidates (or the S minimum value candidates) which are outputted from maximum/minimum value candidate selecting section 201 after all received signal samples are read into maximum/minimum value candidate selecting section 201, calculates an average value of inputs which are smaller than a first threshold value and greater than a second threshold value, and then outputs the average value as a maximum value estimation value (or a minimum value estimation value). Although the above describes the configuration of maximum/minimum value searching section 200 for received signal I, the same configuration is also adopted for received signal Q.

Maximum/minimum value searching section 200 according to this embodiment is used in place of maximum value searching section 104 in FIG. 6 and minimum value searching section 105 in FIG. 7.

A specific example of determining the number of samples for maximum value estimation value MAX/minimum value estimation value MIN in maximum/minimum value searching section 200 will be described below.

GSM reception processing is performed in a burst unit. For example, in the GSM (EDGE) mobile communication standard, one processing unit (burst) includes 156 symbols, and it is necessary to perform demodulation on a per burst-unit basis. In the EDGE mobile communication standard, an 8PSK modulation scheme capable of transmitting 3-bit information per symbol is adopted, and therefore it is obvious that, when the transmitted symbol is 0, a maximum value on an I-axis is taken, when the transmitted symbol is 4, a minimum value on the I-axis is taken, when the transmitted symbol is 2, a maximum value on a Q-axis is taken, and, when the transmitted symbol is 6, a minimum value on the Q-axis is taken. In such a communication standard, the probability of occurrence of each symbol is ⅛, and 20 (= 156/8) symbols are the number of expected symbols having the possibility of taking the maximum or minimum value on each axis, and therefore, generally, by taking 20 as the number of averaging for maximum value search, it is possible to improve the maximum/minimum value estimation accuracy. If the number of averaging having the number of samples more than 20 is taken, symbols that do not take a maximum value are added in average calculation, and estimation accuracy deteriorates. On the other hand, if the number of averaging having the number of samples less than 20 is taken, average calculation is performed using only symbols including a lot of noise, and estimation accuracy deteriorates. Accordingly, by using the characteristics of a modulation scheme for the number of samples, it is possible to improve the maximum/minimum value estimation accuracy.

As described above, according to this embodiment, maximum/minimum value searching section 200 performs maximum/minimum value search so that, when a minimum integer equal to or greater than a value that is obtained by dividing the number of samples used in DC offset processing by the number of modulation symbol points which depends on a modulation scheme is S (S is an integer equal to or greater than 1), maximum/minimum values are averaged so that maximum/minimum values more than/less than a given threshold value among first to S-th maximum/minimum values are excluded from averaging processing, and the average is used as a maximum/minimum value estimation value, so that it is possible to reduce errors between a maximum/minimum value estimation value and a true maximum/minimum vale by excluding a noise/fading component. In other words, it is possible to approximate a maximum/minimum value estimation value to a maximum/minimum value (true maximum/minimum value) without noise or fading.

### Embodiment 3

Embodiment 3 shows an example of DC detection using a known code.

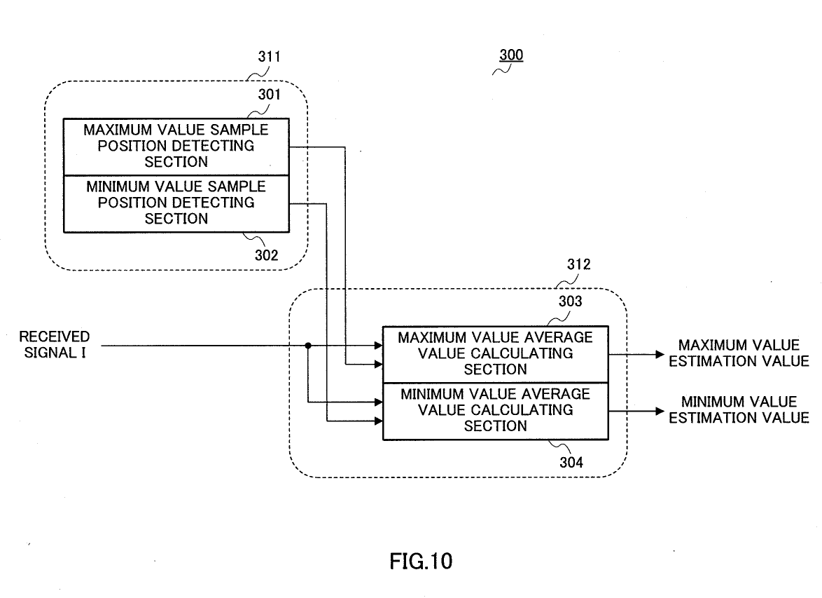

FIG. 10 shows the configuration of a maximum/minimum value searching section of a DC offset removal apparatus according to Embodiment 3 of the present invention. The entire configuration of the DC offset removal apparatus according to this embodiment and the configuration of a DC offset detecting section are the same as those in FIGS. 3 and 4, and therefore the description thereof will not be repeated.

In FIG. 10, maximum/minimum value searching section 300 includes maximum value sample position detecting section 301 that generates a signal indicating a sample position in a received signal that can take a maximum value in known signals which are already known by a mobile equipment upon reception of the received signal; minimum value sample position detecting section 302 that generates a signal indicating a sample position in the received signal that can take a minimum value in the known signals which are already known by the mobile equipment upon reception of the received signal; maximum value average value calculating section 303 that calculates an average value of only signals that can take the maximum value, based on the sample position indicating signal inputted from maximum value sample position detecting section 301, and outputs the average value as a maximum value estimation value; and minimum value average value calculating section 304 that calculates an average value of only signals that can take the minimum value, based on the sample position indicating signal inputted from minimum value sample position detecting section 302, and outputs the average value as a minimum value estimation value.

Maximum value sample position detecting section 301 and minimum value sample position detecting section 302 configure maximum/minimum value sample position detecting section 311, and maximum value average value calculating section 303 and minimum value average value calculating section 304 configure maximum/minimum value average value calculating section 312. Although the above describes the configuration of maximum/minimum value searching section 300 for received signal I, the same configuration is also adopted for received signal Q.

Maximum/minimum value searching section 300 according to this embodiment is used in place of maximum value searching section 104 in FIG. 6 and minimum value searching section 105 in FIG. 7.

A specific example of DC detection using a known code performed by maximum/minimum value searching section 300 will be described below.

For example, in the GSM (EDGE) mobile communication standard, a synchronization acquisition code which is referred to as a training sequence code is embedded for 26 symbols from the 62nd symbol within 156 symbols included in one processing unit (burst) and transmitted. In the EDGE mobile communication standard, an 8PSK modulation scheme is adopted, and it is obvious that, when the transmitted symbol is 0, a maximum value on an I-axis is taken, when the transmitted symbol is 4, a minimum value on the I-axis is taken, when the transmitted symbol is 2, a maximum value on a Q-axis is taken, and, when the transmitted symbol is 6, a minimum value on the Q-axis is taken. In a communication standard using such a synchronization acquisition code, maximum/minimum value search can be performed using only received symbols that should take the maximum/minimum value on each axis by using known transmitted symbol information after synchronization acquisition, so that it is possible to improve maximum/minimum value estimation accuracy. By this means, it is possible to reduce errors between a maximum/minimum value estimation value and a true maximum/minimum vale using a known code.

According to this embodiment, maximum/minimum value searching section 300 uses, as a maximum/minimum value estimation value, a value that is obtained by averaging all samples located at a modulation symbol point that can take a maximum/minimum value, using a known code (training sequence code) which is already informed to the receiver by a base station before reception, so that it is possible to reduce errors between a maximum/minimum value estimation value and a true maximum/minimum vale using the known code.

### Embodiment 4

Embodiment 4 shows an example of algorithm switching according to reception quality.

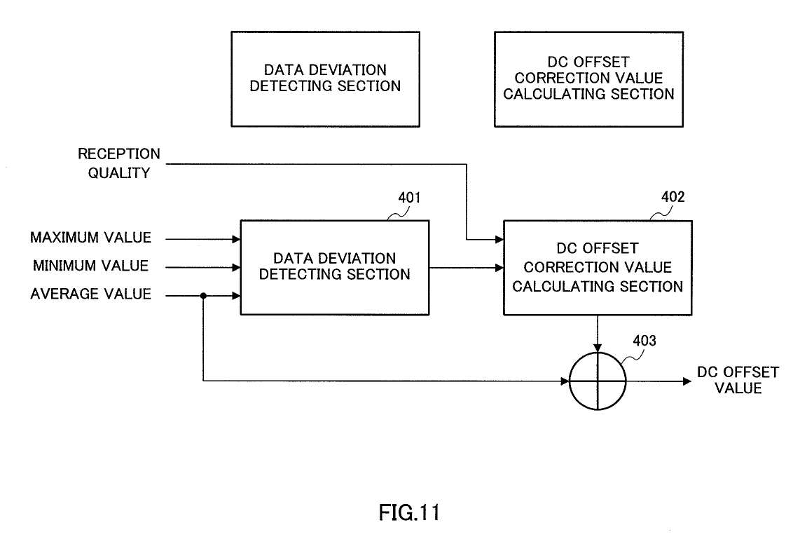

FIG. 11 shows the configuration of a DC offset detecting section of a DC offset removal apparatus according to Embodiment 4 of the present invention. The entire configuration of the DC offset removal apparatus according to this embodiment is the same as that in FIG. 3, and therefore the description thereof will not be repeated. The DC offset detecting section according to this embodiment is applied in place of DC offset detecting section 107 in FIG. 4.

In FIG. 11, DC offset detecting section 400 includes data deviation detecting section 401 that calculates a difference between an average value of a maximum value and a minimum value and an average value outputted from average value calculating section 106 (FIG. 4); DC offset correction value calculating section 402 that receives as input reception quality, updates a first constant using the reception quality, compares a value that takes the absolute value of the difference between the average values with the updated first constant, and outputs 0 as a DC offset correction value if the updated first constant is greater than the absolute value, and otherwise outputs, as a DC offset correction value, a value obtained by multiplying the difference between the average values by a second constant; and DC offset correcting section 403 that calculates a DC offset in which data deviation is eliminated by adding the DC offset correction value and the average value outputted from average value calculating section 106.

A specific example of algorithm switching according to reception quality will be described below.

Examples of reception quality includes BER (Bit Error Rate), SNR (Signal to Noise Ratio) and an input power level at an antenna terminal. When the reception quality is high, random noise is small, and for DC offset compensation, only data deviation becomes dominant. Therefore, as compared with a conventional algorithm in which a DC offset is removed using only an average value, in this embodiment, the DC offset estimation accuracy can be further improved. When the reception quality is low, noise becomes dominant, and therefore there is not much difference between the conventional example and this embodiment. In such a case, it becomes possible to reduce processing load and current consumption when the reception quality is low by performing control to use the above-described algorithm using only an average value.

According to this embodiment, DC offset detecting section 400 switches a first constant by using reception quality of a previous received signal, so that, when the reception quality is high, that is, when there is few noise/fading components, the estimation accuracy of a maximum/minimum value estimation value is high, and therefore by reducing the first constant since, and, when, in contrast, the reception quality is low, the estimation accuracy of a maximum/minimum value estimation value is low, and therefore by increasing the first constant since, it is possible to improve the DC offset estimation accuracy.

The above description is an example of preferred embodiments of the present invention, and the scope of the present invention is not limited to this.

Although, in the embodiments of the present invention, a title of DC offset removal apparatus and DC offset removal method is used, this is for convenience in description. The title may be DC offset correction circuit and DC offset correction method, for example.

Moreover, the type, the number of and a connection method of circuit sections, such as an average value calculating section and a maximum/minimum value searching section, that configures the above-described DC offset removal apparatus, and a modulation scheme, the number of symbols and samples, and the like, are not limited to those described in the above-described embodiments.

As described above, according to the present invention, it is possible to implement a receiver that is capable of highly accurately estimating a DC offset value even in circumstances where there is a lot of noise or even for a received signal having data deviation as in a special case, performs equalization processing on the received signal from which a DC offset is removed using the DC offset value, and improves bit error rate characteristics.

Accordingly, a DC offset removal apparatus and a DC offset removal method of the present invention can be used as part of reception processing for mobile telephones for mobile communication. Particularly, in the GSM scheme which is mainly used in Europe and the EDGE (Enhanced Data GSM Environment) scheme which is a third-generation version of the GSM scheme, it is possible to reduce the processing load of equalization processing at a subsequent stage and the circuit scale, and contribute to implementation of low-cost mobile telephones or extension of continuous standby time or continuous call time. In addition, the DC offset removal apparatus and DC offset removal method of the present invention are useful as a receiver for digital mobile communication that is provided with a radio section of a direct conversion scheme.

What is claimed is:

1. A DC offset removal apparatus comprising:
a maximum/minimum value searching section that calculates a maximum value estimation value and a minimum value estimation value of received signals which are converted into digital baseband signals;
a DC offset detecting section that uses half of a sum of the maximum value estimation value and the minimum value estimation value based on the maximum value estimation value and the minimum value estimation value calculated by the maximum/minimum value searching section, as a DC offset value; and
a DC offset removal section that removes the DC offset value calculated by the DC offset detecting section, from the received signals.

2. A DC offset removal apparatus comprising:
a maximum/minimum value searching section that calculates a maximum value estimation value and a minimum value estimation value of received signals which are converted into digital baseband signals;
an average value calculating section that calculates an average value of the received signals;
a DC offset detecting section that calculates a DC offset value based on the maximum value estimation value and the minimum value estimation value calculated by the maximum/minimum value searching section and the average value calculated by the average value calculating section; and
a DC offset removal section that removes the DC offset value calculated by the DC offset detecting section, from the received signals, wherein:
when an absolute value of a difference between the average value and half of a sum of the maximum value estimation value and the minimum value estimation value is equal to or greater than a first constant (the first constant is an integer equal to or greater than 0), the DC offset detecting section uses, as the DC offset value, a sum of the average value and a value obtained by multiplying a second constant (the second constant is a real number equal to or greater than 0 and less than 1) by a result of subtracting the average value from the half of a sum of the maximum value estimation value and the minimum value estimation value; and
when the absolute value of the difference between the average value and the half of a sum of the maximum value estimation value and the minimum value estimation value is smaller than the first constant, the DC offset detecting section uses the average value as the DC offset value.

3. The DC offset removal apparatus according to claim 1, wherein, when a minimum integer equal to or greater than a value that is obtained by dividing the number of samples to be used in DC offset processing by the number of modulation symbol points which depends on a modulation scheme is S (S is an integer equal to or greater than 1), the maximum/minimum value searching section uses a value obtained by averaging first to S-th maximum/minimum values, as the maximum/minimum value estimation value.

4. The DC offset removal apparatus according to claim 1, wherein the maximum/minimum value searching section uses, as the maximum/minimum value estimation value, a value obtained by averaging all samples located at modulation symbol points that can take a maximum/minimum value, using a known code or a training sequence code which is already informed by a base station before reception.

5. The DC offset removal apparatus according to claim 1, wherein, when a minimum integer equal to or greater than a value that is obtained by dividing the number of samples to be used in DC offset processing by the number of modulation symbol points which depends on a modulation scheme is S (S is an integer equal to or greater than 1), the maximum/minimum value searching section excludes maximum/minimum values more than/less than a predetermined threshold value among first to S-th maximum/minimum values from averaging processing and averages maximum/minimum values, and uses the average as the maximum/minimum value estimation value.

6. The DC offset removal apparatus according to claim 2, wherein the DC offset detecting section switches the first constant using reception quality of a previous received signal.

7. A DC offset removal method comprising:
a step of calculating a maximum value estimation value and a minimum value estimation value of received signals which are converted into digital baseband signals;
a DC offset detecting step of using half of the maximum value estimation value and the minimum value estimation value, as a DC offset value; and
a step of removing the calculated DC offset value from the received signals.

8. A DC offset removal method comprising:
a step of calculating a maximum value estimation value and a minimum value estimation value of received signals which are converted into digital baseband signals;
a step of calculating an average value of the received signals;
a DC offset detecting step of calculating a DC offset value based on the calculated maximum value estimation value and minimum value estimation value and the average value; and
a step of removing the calculated DC offset value from the received signals.

9. The DC offset removal method according to claim 8, wherein:
in the DC offset detecting step:
when an absolute value of a difference between the average value and half of a sum of the maximum value estimation value and the minimum value estimation value is equal to or greater than a first constant (the first constant is an integer equal to or greater than 0), a sum of the average value and a value obtained by multiplying a second constant (the second constant is a real number equal to or greater than 0 and less than 1) by a result of subtracting the average value from the half of a sum of the maximum value estimation value and the minimum value estimation value, is used as the DC offset value; and
when the absolute value of the difference between the average value and the half of a sum of the maximum value estimation value and the minimum value estimation value is smaller than the first constant, the average value is used as the DC offset value.
